(19) United States
(12) Patent Application Publication
(10) Pub. No.: US 2020/0362603 A1
(43) Pub. Date: Nov. 19, 2020

(54) VEHICLE DOOR WITH USER GESTURE DETECTION

(71) Applicant: GM Global Technology Operations LLC, Detroit, MI (US)

(72) Inventor: Venkateshwar R. Aitharaju, Troy, MI (US)

(73) Assignee: GM Global Technology Operations LLC, Detroit, MI (US)

(21) Appl. No.: 16/414,286

(22) Filed: May 16, 2019

(51) Int. Cl. E05B 81/78; B60R 25/20; B60J 5/04; B60R 13/08

(52) U.S. Cl. CPC E05B 81/78; B60R 25/2045; B60R 25/2054; E05Y 2900/531; B60J 5/0415; B60R 13/0869; B60J 5/0413

(57) ABSTRACT

A door assembly has a door panel for an entryway into a vehicle having an electronic controller. The door assembly also includes a door locking system having a latch mechanism for selectively latching the door panel to and unlatching the door panel from the vehicle body. The door assembly additionally includes an electronic circuit embedded in the door panel, having an electronic chip configured to detect a gesture of a vehicle user proximate the door panel, and configured to generate a signal indicative of the detected gesture. Each of the latch mechanism and the electronic circuit is in operative communication with the controller. The controller is configured to receive the signal from the electronic circuit and command the latch mechanism to either latch or unlatch the door panel from the vehicle body in response to the detected gesture. A method of unlatching a vehicle door panel is also disclosed.

### INTRODUCTION

The disclosure relates to access doors, and, in particular, to a door assembly for a motor vehicle with vehicle user gesture detection.

In general, doors are used to control passage between separate spaces. A typical door is a panel that swings on hinges, slides, or rotates inside a space. When open, doors admit ventilation and light. A door may be used to control the physical atmosphere within a space so that an interior may be more effectively heated or cooled. Doors also act as a barrier to noise, inclement weather, and physical intrusion into a specifically defined space.

A typical vehicle has at least one door for accessing an interior of the vehicle. Such a door usually has a latch mechanism for maintaining the door in a locked state until access into or egress from the vehicle is required. Conventionally, the latch mechanism is actuated by an outside door handle to gain access to the interior of the vehicle, and by an interior door handle to facilitate exit from same. Actuation of the latch mechanism may also be locked or disabled to thereby prevent unauthorized access into the vehicle.

### SUMMARY

A door assembly for a vehicle having a vehicle body defining an entryway into a vehicle interior has an electronic controller and a door panel for the entryway. The door panel has a vehicle exterior-facing surface and a vehicle interior-facing surface. The door assembly also includes a door locking system having a latch mechanism configured to selectively latch the door panel to and unlatch the door panel from the vehicle body. The door assembly additionally includes an electronic circuit embedded in the door panel, including an electronic chip configured to detect a gesture of a vehicle user proximate the door panel, and configured to generate a signal indicative of the detected gesture. Each of the latch mechanism and the electronic circuit is in operative communication with the electronic controller. The electronic controller is configured to receive the signal from the electronic circuit and command the latch mechanism to either latch or unlatch the door panel from the vehicle body as needed in response to the detected gesture.

Either one or both of the vehicle exterior-facing surface and the vehicle interior-facing surface may be structured from an electrically nonconductive material, such as fiberglass.

The electronic circuit may be embedded in a composite preform, and the composite preform may be arranged between the vehicle exterior-facing surface and the vehicle interior-facing surface.

Either one or both of the vehicle exterior-facing surface and the vehicle interior-facing surface may be structured from an electrically conductive material, such as carbon fiber.

The door panel may include a first electrically insulating panel and a second electrically insulating panel. In such an embodiment, the electronic circuit may be arranged between the first and second electrically insulating panels.

The first insulating panel may be arranged proximate the vehicle exterior-facing surface and the second insulating panel may be arranged proximate the vehicle interior-facing surface.

At least one of the first electrically insulating panel and the second electrically insulating panel may be a fiberglass veil.

The door panel may additionally include a scrim sheet arranged between the second electrically insulating panel and the vehicle interior-facing surface.

The electronic circuit may be in communication with the electronic controller via a wireless network. Alternatively, the electronic circuit may be in communication with the electronic controller via a Controller Area Network (CAN) bus.

The electronic chip may be configured to detect the gesture by recognizing a change in magnetic capacitance of air proximate the door panel.

The door panel may be characterized by an absence of an exterior door handle and an interior door handle.

A method of unlatching a door panel for an entryway in a vehicle is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a top view of a vehicle illustrating a vehicle interior, a plurality of the vehicle door panels, and a vehicle user positioned external to the interior.

FIG. 2 is a schematic partial perspective top view of a vehicle interior illustrating one of the door panels shown in FIG. 1, the vehicle user situated in the interior, and a door locking system having an embodiment of an electronic circuit for user gesture detection and recognition embedded in the door panel, according to the disclosure.

FIG. 3 is a schematic partial perspective exploded view of the vehicle door panel with another embodiment of the electronic circuit embedded in the door panel shown in FIG. 2, according to the disclosure.

FIG. 4 is a schematic partial perspective exploded view of the vehicle door panel with yet another embodiment of the electronic circuit embedded in the door panel shown in FIG. 2, according to the disclosure.

FIG. 5 is a schematic exterior plan view of an embodiment of the vehicle door panel, according to the disclosure.

FIG. 6 illustrates a method of selective latching and unlatching of the door panel shown in FIGS. 1-5.

### DETAILED DESCRIPTION

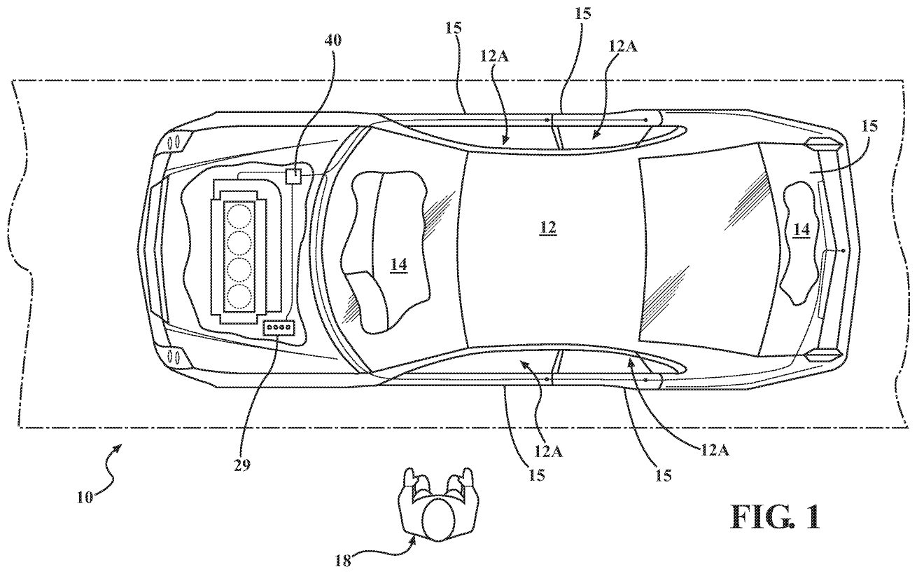

Referring to the drawings, wherein like reference numbers refer to like components, FIG. 1 shows a vehicle 10 having a vehicle body 12 defining a vehicle interior 14 and an entryway 12A thereto. The vehicle 10 also includes a plurality of door assemblies 15. Although only a single representative door assembly 15 is shown in FIG. 1, it is to be understood that the vehicle 10 may have as many door assemblies 15 as dictated by the specific vehicle design. Each door assembly 15 is configured to selectively open and close the entryway 12A into the vehicle interior 14, such as by a user or operator 18 of the vehicle 10. Although the representative door assembly 15 is shown in FIG. 1 as a vehicle side door, the door assembly 15 may also be configured as a trunk lid, a tailgate (not shown), or another type of a door for access into the vehicle 10.

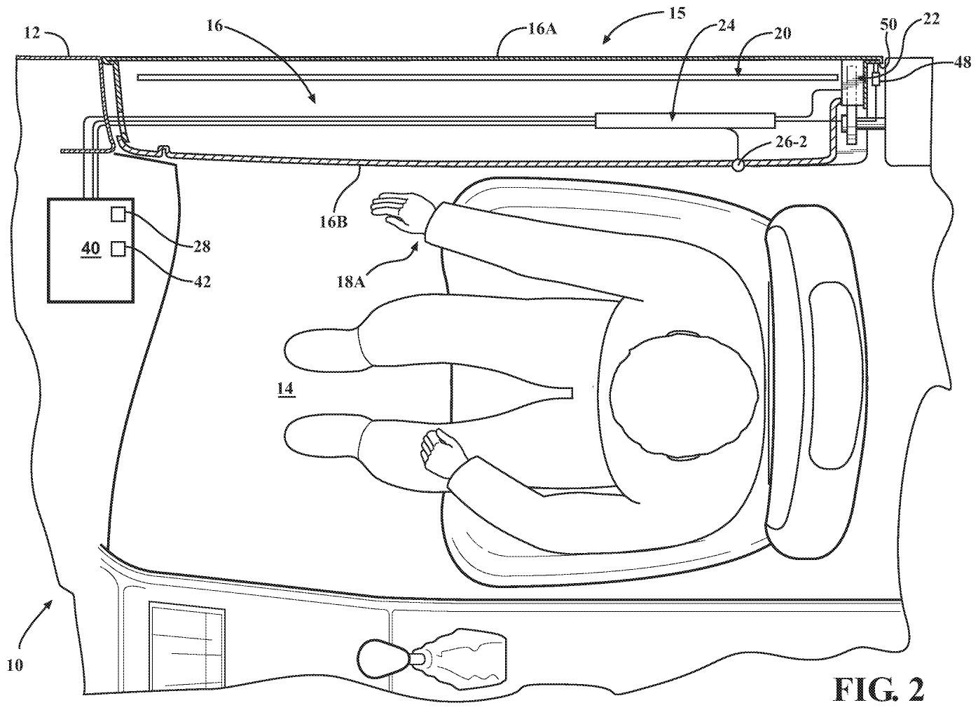

As shown in FIG. 2, the door assembly 15 includes a door panel 16. Each door panel 16 includes a vehicle exterior-facing surface 16A and an interior-facing surface 16B. The vehicle 10 also includes a door locking system 20. The door locking system 20 is configured to selectively lock and unlock a particular door panel 16 in response to a predetermined gesture of the vehicle user 18. Specifically, the door locking system 20 includes at least one latch mechanism 22 configured to selectively latch the respective door panel 16 to and unlatch the subject door from the vehicle body 12 as needed. Commonly, vehicle doors include exterior door-release handles positioned on the exterior-facing surfaces, such as the surface 16A, and interior door-release handles positioned on the interior-facing surfaces, such as the surface 16B. In such vehicle doors, the associated latch mechanism 22 is configured to be released via the interior door-release handle 20, as well as via the exterior door-release handle 26 to unlatch the respective door panel 16 and permit access into the vehicle interior 14. However, the presently considered door panel 16 may be specifically configured to dispense with the interior door-release handle or the exterior door-release handle. In other words, the door 16 may be characterized by the absence of either the interior door-release handle or the exterior door-release handle to release and open the door.

The door locking system 20 also includes an electronic circuit 24 embedded in the door panel 16 and having an electronic capacitive chip 26-1 configured to detect a gesture 18A of the vehicle user 18 proximate the door panel. Specifically, the gesture 18A is a predetermined deliberate physical movement or expression of an authorized vehicle user 18, as will be described in detail below. The capacitive chip 26-1 is configured to detect the gesture 18A by recognizing a change in magnetic capacitance of air proximate the door panel 16, i.e., where the gesture 18A of the vehicle user 18 is to be detected. The detected change in magnetic capacitance of air proximate the door panel 16 is reflected by a change in electrical capacitance of the electrical circuit 24. In other words, such an embodiment of the electronic circuit 24 is configured as a capacitive circuit. The electronic circuit 24 is also configured to generate a signal 28 in response to the detected gesture 18A. An energy storage device 29 (shown in FIG. 1), such as a battery, is configured to power the electronic circuit 24.

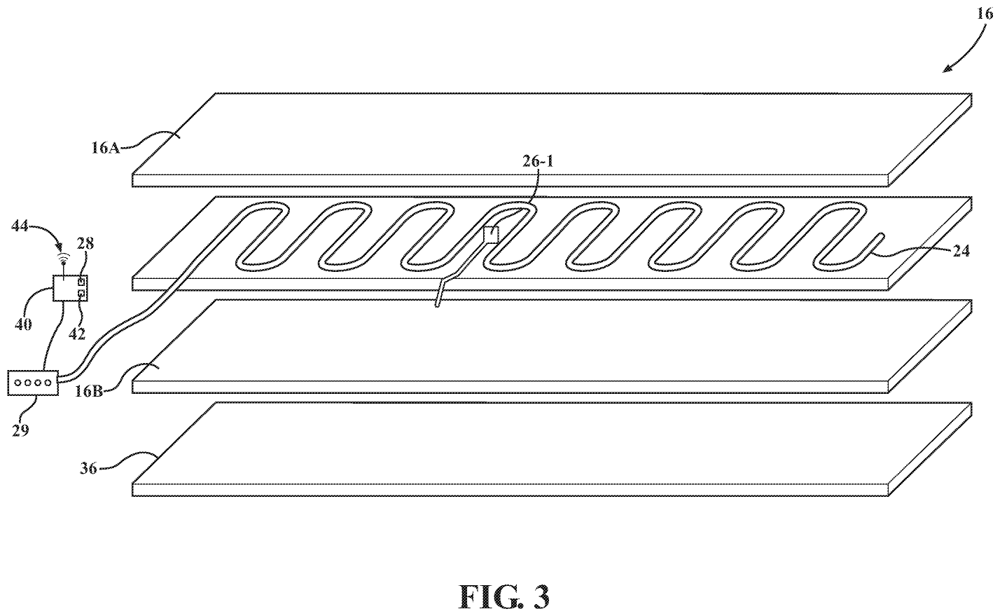

As shown in FIG. 3, at least one of the vehicle exterior-facing surface 16A and the vehicle interior-facing surface 16B may be structured from an electrically nonconductive material. Such an electrically nonconductive material may, for example, be fiberglass. In the embodiment of the door panel 16 shown in FIG. 3, the electronic circuit 24 may be embedded in a composite preform 30. As shown, the composite preform 30 may be arranged between the vehicle exterior-facing surface 16A and the vehicle interior-facing surface 16B. In other words, the composite preform 30 may incorporate the electronic circuit 24 as part of a molded unitary component, i.e., a door panel 16 having unitary construction. The composite preform 30 may be manufactured as an individual component and shipped to an assembly plant for installation onto the vehicle 10.

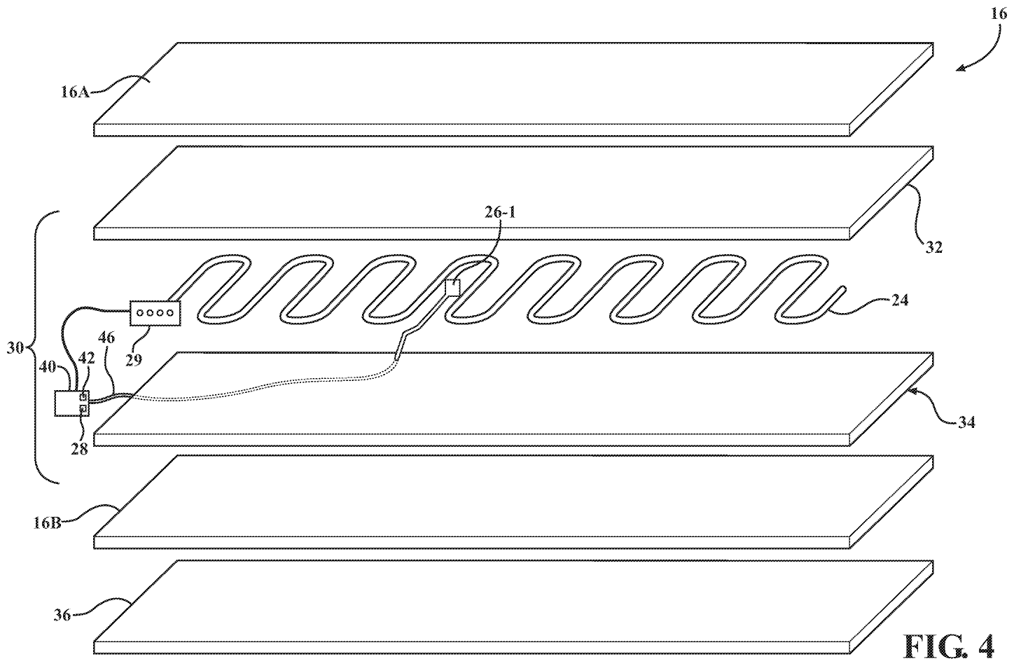

Alternatively, as shown in FIG. 4, at least one of the vehicle exterior-facing surface 16A and the vehicle interior-facing surface 16B may be structured from an electrically conductive material. Such an electrically conductive material may, for example, be carbon fiber. In the FIG. 3 embodiment of the door panel 16, the door panel may include a first electrically insulating panel 32 and a second electrically insulating panel 34. The first insulating panel 32 may be arranged proximate the vehicle exterior-facing surface 16A while the second insulating panel 34 may be arranged proximate the vehicle interior-facing surface 16B. Furthermore, in such an embodiment, the electronic circuit 24 may be arranged between the first and second electrically insulating panels 32, 34. At least one of the first and second electrically insulating panels 32, 34 may be a fiberglass veil.

The door panel 16 may additionally include a scrim sheet 36 arranged between the second electrically insulating panel 34 and the vehicle interior-facing surface 16B. The scrim sheet 36 may be a thin plastic film employed as a protective layer to protect the second electrically insulating panel 34 from damage during shipping and handling of the door panel 16 to an assembly plant for installation onto the vehicle 10. In either the embodiment of FIG. 3 or 4, the door panel 16 may have a fully finished vehicle exterior-facing surface 16A, i.e., painted to match the color of the vehicle body 12. On the other hand, the vehicle interior-facing surface 16B may be configured to accept attachment to an interior trim panel 38.

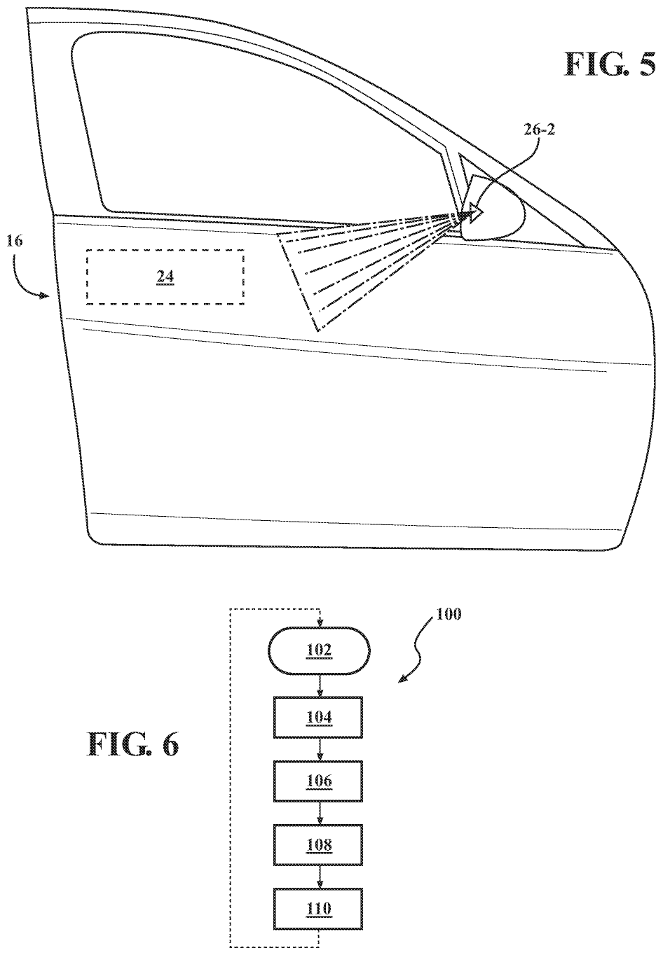

An alternative embodiment of the electronic circuit 24 embedded in the door panel 16 may include an infra-red sensor 26-2 (shown in FIGS. 2 and 5). Similar to the electronic chip 26-1, the infrared sensor 26-2 would be configured to detect a gesture 18A of the vehicle user 18 proximate the door panel 16. Depending on whether the gesture 18A is to be detected externally to the vehicle body 12 or from the interior 14, the infrared sensor 26-2 may be mounted to the door panel 16 on the exterior-facing surface 16A (shown in FIG. 5) or on the vehicle interior-facing surface 16B (shown in FIG. 2). The infrared sensor 26-2 is specifically configured to illuminate an area proximate the door panel 16, i.e., where the gesture 18A of the vehicle user 18 is to be detected.

Each of the latch mechanism 22 and the electronic circuit 24 is in operative communication with an electronic controller 40. As shown in FIG. 1, the controller 40 is arranged on the vehicle body 12 relative to the vehicle interior 14. The controller 40 may be a vehicle body controller configured to regulate various vehicle systems and functions, such as a Heating Ventilation, and Air Conditioning (HVAC) system, infotainment, and vehicle interior and exterior lighting, or a stand-alone control unit. In either configuration, the controller 40 includes a processor and tangible, non-transitory memory which includes instructions for the door locking system 20 programmed therein. As such, the processor is configured to execute the instructions from memory in the controller 40 to regulate a subject vehicle system or function, including the operation of the door locking system 20.

The electronic controller 40 may receive from an external source, such as via an electronically coded communication, or be pre-programmed with, a preapproved gesture 42, configured to permit the electronic controller to either latch or unlatch the door panel 16. Accordingly, the preapproved gesture 42 of the vehicle operator 18 may serve as a form of passcode to enter or exit the vehicle 10. The electronic controller 40 is configured to receive the signal 28 from the electronic circuit 24. The electronic controller 40 is configured, i.e., structured and programmed, to recognize the detected gesture 18A based on the received signal 28 and correlate or compare the detected gesture 18A to the preapproved gesture 42. Additionally, the electronic controller 40 is configured to command the latch mechanism 22 to either latch or unlatch the door panel 16 from the vehicle body 12 in response to the detected gesture 18A matching the preapproved gesture 42.

Accordingly, the door locking system 20 also includes at least a portion of the electronic controller 40 that is responsible for regulating operation of the latch mechanisms 22. As shown in FIG. 2, the electronic circuit 24 may be in communication with the electronic controller 40 via a wireless network 44. Alternatively, as shown in FIG. 3, the electronic circuit 24 may be in communication with the electronic controller 40 via a Controller Area Network (CAN) bus 46. In general, a CAN bus permits microcontrollers and other electronic devices to communicate with each other in applications without a host computer. A CAN bus is a message-based protocol, designed originally for multiplex electrical wiring within automobiles to save on copper.

The door locking system 20 may also include a door actuator 48 arranged between the door panel 16 and the vehicle body 12. The door actuator 48 is configured to push and move or shift the door panel 16, and thereby separate the door panel 16 away from the vehicle body 12 by a predefined distance. Such a distance may be configured to facilitate sufficient access for the vehicle user 18 to a hem portion 50 (shown in FIG. 2) of the door panel 16. The vehicle user 18 may therefore access the door hem 50 following the actuation of the latch mechanism 22 and unlatching of the door panel 16 from the vehicle body 12 in response to the signal 28, and the door panel 16 having been pushed away from the vehicle body 12 via the door actuator 48. After door panel 16 has been unlatched and the vehicle user 18 has gained access to the vehicle interior 14, or, alternatively, has exited the vehicle 10, and the door panel has been closed, the latch mechanism 22 may re-latch the door panel to the vehicle body 12.

Overall, the door locking system 20 permits the vehicle 10 to dispense with the need for a traditional door handle arranged on the vehicle exterior-facing surface 16A of the door panel 16. Additionally, the door actuator 48 may facilitate the separation of the door panel 16 from the vehicle body 12 when the latch mechanism 22 unlatches of the door panel from the vehicle body for egress of the vehicle user 18. Accordingly, the use of the door locking system 20 using the door actuator 48 may dispense with the need for the vehicle interior-facing surface 16B of the door panel 16 to be configured without a door release handle.

A method 100 of unlatching the door panel 16 is shown in FIG. 6, and described below with reference to the structure shown in FIGS. 1-5. The method commences in frame 202 with detecting, via the electronic circuit 24, a gesture 18A of the vehicle user 18 proximate the door panel 16. As described with respect to FIGS. 1-5, the electronic circuit may include either an electronic chip 26-1 or an infra-red sensor 26-2 configured to detect the gesture 18A. The gesture 18A may be detected externally to the vehicle body 12 or from the interior 14 of the vehicle 10. Following frame 102, the method advances to frame 104. In frame 104, the method includes generating, via the electronic circuit 24, the signal 28 indicative of the detected gesture 18A. From frame 104, the method moves on to frame 106.

In frame 106, the method includes receiving, via the electronic controller 40, the signal 28 from the electronic circuit 24. After frame 106, the method proceeds to frame 108, where the method includes commanding, via the electronic controller 40, to one of latch and unlatch the door panel 16 from the vehicle body 12 via the latch mechanism 22 in response to the detected signal 28. After frame 108, the method will generally proceed to frame 110, where the method includes re-latching the door panel 16 to the vehicle body 12 via the latch mechanism 22 once the door panel is closed. Following frame 110, the method may return to frame 102 for detecting, via the electronic circuit 24, another gesture 18A of the vehicle user 18 proximate the door panel 16, either externally to the vehicle body 12, to facilitate ingress of the vehicle user 18 into the vehicle, or from the interior 14 to provide egress of the user therefrom.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A door assembly for a vehicle having a vehicle body defining an entryway into a vehicle interior, and also having an electronic controller, the door assembly comprising:
a door panel for the entryway, wherein the door panel has a vehicle exterior-facing surface and a vehicle interior-facing surface; and
a door locking system having:
a latch mechanism configured to selectively latch the door panel to and unlatch the door panel from the vehicle body; and
an electronic circuit embedded in the door panel, having an electronic chip configured to detect a gesture of a vehicle user proximate the door panel, and configured to generate a signal indicative of the detected gesture;
wherein:
each of the latch mechanism and the electronic circuit is in operative communication with the electronic controller; and
the electronic controller is configured to receive the signal from the electronic circuit and command the latch mechanism to one of latch and unlatch the door panel from the vehicle body in response to the detected gesture.

2. The door assembly of claim 1, wherein at least one of the vehicle exterior-facing surface and the vehicle interior-facing surface is structured from an electrically nonconductive material.

3. The door assembly of claim 2, wherein the electronic circuit is embedded in a composite preform, and wherein the composite preform is arranged between the vehicle exterior-facing surface and the vehicle interior-facing surface.

4. The door assembly of claim 1, wherein at least one of the vehicle exterior-facing surface and the vehicle interior-facing surface is structured from an electrically conductive material.

5. The door assembly of claim 4, wherein the door panel includes a first electrically insulating panel and a second electrically insulating panel, wherein the electronic circuit is arranged between the first and second electrically insulating panels.

6. The door assembly of claim 5, wherein the first insulating panel is arranged proximate the vehicle exterior-facing surface and the second insulating panel is arranged proximate the vehicle interior-facing surface.

7. The door assembly of claim 5, wherein at least one of the first electrically insulating panel and the second electrically insulating panel is a fiberglass veil.

8. The door assembly of claim 1, wherein the door panel additionally includes a scrim sheet arranged between the second electrically insulating panel and the vehicle interior-facing surface.

9. The door assembly of claim 1, wherein the electronic chip is configured to detect the gesture by recognizing a change in magnetic capacitance of air proximate the door panel.

10. A vehicle comprising:
a vehicle body defining an entryway into a vehicle interior;
an electronic controller;
a door panel for the entryway, wherein the door panel has a vehicle exterior-facing surface and a vehicle interior-facing surface, and is configured to selectively open and close the entryway assembly; and
a door locking system having:
a latch mechanism configured to selectively latch the door panel to and unlatch the door panel from the vehicle body; and
an electronic circuit embedded in the door panel, having an electronic chip configured to detect a gesture of a vehicle user proximate the door panel, and configured to generate a signal indicative of the detected gesture;
wherein:
each of the latch mechanism and the electronic circuit is in operative communication with the electronic controller; and
the electronic controller is configured to receive the signal from the electronic circuit and command the latch mechanism to one of latch and unlatch the door panel from the vehicle body in response to the detected gesture.

11. The vehicle of claim 10, wherein at least one of the vehicle exterior-facing surface and the vehicle interior-facing surface is structured from an electrically nonconductive material.

12. The vehicle of claim 11, wherein the electronic circuit is embedded in a composite preform, and wherein the composite preform is arranged between the vehicle exterior-facing surface and the vehicle interior-facing surface.

13. The vehicle of claim 10, wherein at least one of the vehicle exterior-facing surface and the vehicle interior-facing surface is structured from an electrically conductive material.

14. The vehicle of claim 13, wherein the door panel includes a first electrically insulating panel and a second electrically insulating panel, wherein the electronic circuit is arranged between the first and second electrically insulating panels.

15. The vehicle of claim 14, wherein the first insulating panel is arranged proximate the vehicle exterior-facing surface and the second insulating panel is arranged proximate the vehicle interior-facing surface.

16. The vehicle of claim 14, wherein at least one of the first electrically insulating panel and the second electrically insulating panel is a fiberglass veil.

17. The vehicle of claim 10, wherein the door panel additionally includes a scrim sheet arranged between the second electrically insulating panel and the vehicle interior-facing surface.

18. The vehicle of claim 10, wherein the electronic chip is configured to detect the gesture by recognizing a change in magnetic capacitance of air proximate the door panel.

19. A method of unlatching a door panel for an entryway into a vehicle body, the method comprising:
detecting, via an electronic circuit embedded in the door panel, a gesture of a vehicle user proximate the door panel;
generating, via the electronic circuit, a signal indicative of the detected gesture;
receiving, via an electronic controller, the signal from the electronic circuit; and
commanding, via the electronic controller, to one of latch and unlatch the door panel from the vehicle body via a latch mechanism in response to the detected signal.

20. The method of claim 19, wherein the electronic circuit includes one of an electronic chip and an infra-red sensor configured to detect the gesture of the vehicle user.
